(19) United States
(12) Patent Application Publication
(10) Pub. No.: US 2021/0345096 A1
(43) Pub. Date: Nov. 4, 2021

(54) APPARATUS AND METHOD FOR MANAGING USER EQUIPMENT CAPABILITY INFORMATION

(71) Applicant: GUANGDONG OPPO MOBILE TELECOMMUNICATIONS CORP., LTD., Dongguan (CN)

(72) Inventors: YONGSHENG SHI, Palo Alto, CA (US); NING YANG, Dongguan (CN); JIANHUA LIU, Dongguan (CN)

(21) Appl. No.: 17/373,992

(22) Filed: Jul. 13, 2021

Related U.S. Application Data
(63) Continuation of application No. PCT/CN2019/072583, filed on Jan. 21, 2019.
(60) Provisional application No. 62/793,261, filed on Jan. 16, 2019.

(51) Int. Cl. H04W 8/24; H04W 48/16

(52) U.S. Cl. CPC H04W 8/24; H04W 84/042; H04W 48/16

(57) ABSTRACT

An apparatus and a method for managing user equipment (UE) capability information are provided. A method for managing UE capability information of a UE includes receiving an indication that one of a plurality of types of UE capability identifier and/or indication separated from each other is to be used from a network and managing UE capability information using the one of the plurality of types of UE capability identifier and/or indication separated from each other.

### CROSS-REFERENCE TO RELATED APPLICATIONS

The present application is a continuation application of International Application No. PCT/CN2019/072583, filed on Jan. 21, 2019, which claims priority to U.S. provisional application No. 62/793,261, filed on Jan. 16, 2019. The present application claims priority and the benefit of the above-identified applications and the above-identified applications are incorporated by reference herein in their entireties.

### BACKGROUND OF DISCLOSURE

### 1. Field of Disclosure

The present disclosure relates to the field of communication systems, and more particularly, to an apparatus and a method for managing user equipment (UE) capability information.

### 2. Description of Related Art

In long term evolution (LTE) and new radio (NR) systems, such as 4G LTE and 5G systems, a user equipment (UE) needs to report, to a network, radio capabilities of the UE according to a request from the network. This typically happens during a UE registration procedure.

According to the request from the network, the UE needs to send, to the network, all supported radio capabilities of the UE over an air. Although the LTE and NR systems can provide much bigger bandwidth than previous generation cellular networks (e.g. 3G and 2G), a size of UE capability message is still a concern. Over the air, a radio resource control (RRC) message limit is about 8K bytes. As for today, there is no defined mechanism to segment the RRC message.

For radio capabilities of the UE, most sizable part is band combinations. At present, most UEs are able to support 3 or 5 carrier aggregations (CAs), meaning the UE needs to report, to the network, all its supported bands and CA combinations.

Therefore, there is a need for an apparatus and a method for managing user equipment (UE) capability information.

### SUMMARY

An object of the present disclosure is to propose an apparatus and a method of for managing user equipment (UE) capability information capable of providing high reliability.

In a first aspect of the present disclosure, a user equipment (UE) for managing UE capability information includes a memory, a transceiver, and a processor coupled to the memory and the transceiver. The processor is configured to control the transceiver to receive an indication that one of a plurality of types of UE capability identifier and/or indication separated from each other is to be used from a network, and the processor is configured to manage UE capability information using the one of the plurality of types of UE capability identifier and/or indication separated from each other.

In a second aspect of the present disclosure, a method for managing user equipment (UE) capability information of a UE includes receiving an indication that one of a plurality of types of UE capability identifier and/or indication separated from each other is to be used from a network and managing UE capability information using the one of the plurality of types of UE capability identifier and/or indication separated from each other.

In a third aspect of the present disclosure, a network for managing user equipment (UE) capability information includes a memory, a transceiver, and a processor coupled to the memory and the transceiver. The processor is configured to control the transceiver to transmit, to a UE, an indication that one of a plurality of types of UE capability identifier and/or indication separated from each other is to be used, and the processor is configured to manage UE capability information using the one of the plurality of types of UE capability identifier and/or indication separated from each other.

In a fourth aspect of the present disclosure, a method for managing user equipment (UE) capability information of a network includes transmitting, to a UE, an indication that one of a plurality of types of UE capability identifier and/or indication separated from each other is to be used and managing UE capability information using the one of the plurality of types of UE capability identifier and/or indication separated from each other.

In a fifth aspect of the present disclosure, a non-transitory machine-readable storage medium has stored thereon instructions that, when executed by a computer, cause the computer to perform the above method.

In a sixth aspect of the present disclosure, a terminal device includes a processor and a memory configured to store a computer program. The processor is configured to execute the computer program stored in the memory to perform the above method.

In a seventh aspect of the present disclosure, a network node includes a processor and a memory configured to store a computer program. The processor is configured to execute the computer program stored in the memory to perform the above method.

### BRIEF DESCRIPTION OF DRAWINGS

In order to more clearly illustrate the implementations of the present disclosure or related art, the following figures will be described in the implementations are briefly introduced. It is obvious that the drawings are merely some implementations of the present disclosure, a person having ordinary skill in this field can obtain other figures according to these figures without paying the premise.

FIG. 1 is a block diagram of a user equipment and a network for managing user equipment (UE) capability information according to an implementation of the present disclosure.

FIG. 2 is a flowchart illustrating a method for managing user equipment (UE) capability information of a user equipment according to an implementation of the present disclosure.

FIG. 3 is a flowchart illustrating a method for managing user equipment (UE) capability information of a network according to an implementation of the present disclosure.

FIG. 4 is a flowchart illustrating a method for managing user equipment (UE) capability information of a user equipment and a network according to an implementation of the present disclosure.

FIG. 5 is a flowchart illustrating a method for managing user equipment (UE) capability information of a user equipment and a network according to an implementation of the present disclosure.

FIG. 6 is a block diagram of a system for wireless communication according to an implementation of the present disclosure.

### DETAILED DESCRIPTION OF IMPLEMENTATIONS

Implementations of the present disclosure are described in detail with the technical matters, structural features, achieved objects, and effects with reference to the accompanying drawings as follows. Specifically, the terminologies in the implementations of the present disclosure are merely for describing the purpose of the certain implementation, but not to limit the disclosure.

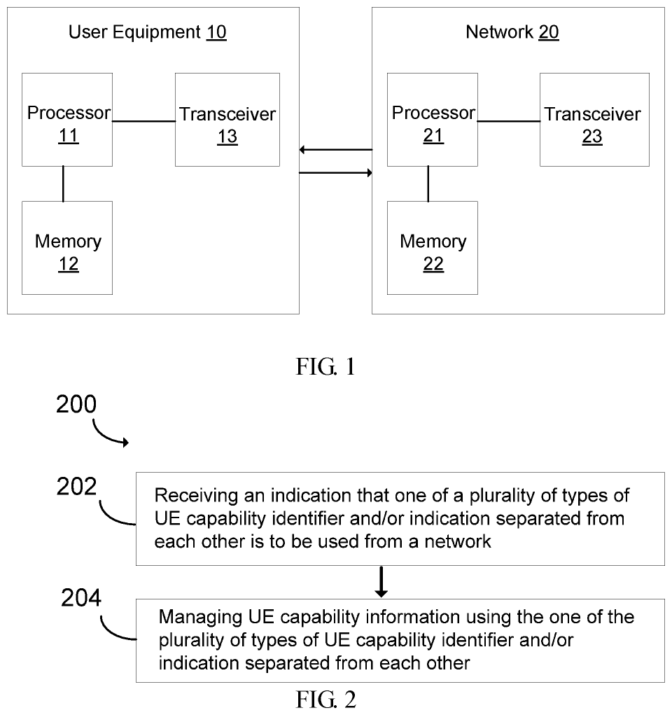

FIG. 1 illustrates that, in some implementations, a user equipment (UE) 10 and a network 20 for managing user equipment (UE) capability information according to an implementation of the present disclosure are provided. The UE 10 may include a processor 11, a memory 12, and a transceiver 13. The network 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry to process radio frequency signals. When the implementations are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via various means are known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) release 14, 15, 16, and beyond. UEs communicate with each other directly via a sidelink interface such as a PC5 interface.

In some implementations, the processor 11 is configured to control the transceiver 13 to receive an indication that one of a plurality of types of UE capability identifier and/or indication separated from each other is to be used from the network 20 and the processor 11 is configured to manage UE capability information using the one of the plurality of types of UE capability identifier and/or indication separated from each other.

In some implementations, the plurality of types of UE capability identifier and/or indication include a manufacturer UE capability identifier and/or indication and a public land network based on public land mobile network (PLMN) UE capability identifier and/or indication. The manufacturer UE capability identifier and/or indication is optionally configured in the UE 10. The manufacturer UE capability identifier and/or indication and the PLMN UE capability identifier and/or indication are separately maintained in separate identifier and/or indication pools.

In some implementations, the transceiver 13 is configured to report, to the network 20, the manufacturer UE capability identifier and/or indication. The transceiver 13 receives a determination that the network 20 does not support the manufacturer UE capability identifier and/or indication or the network 20 rejects to use the manufacturer UE capability identifier and/or indication when the transceiver 13 reports, to the network 20, the manufacturer UE capability identifier and/or indication. The transceiver 13 receives a request of providing the UE capability information from the network when the transceiver receives the determination that the network 20 does not support the manufacturer UE capability identifier and/or indication or the network 20 rejects to use the manufacturer UE capability identifier and/or indication. The transceiver 13 reports, to the network 20, the UE capability information when the transceiver 13 receives the request of providing the UE capability information from the network 20.

In some implementations, the transceiver 13 receives an allocation of the PLMN UE capability identifier and/or indication when the transceiver 13 reports, to the network 20, the UE capability information. The processor 11 is configured to negotiate another of the plurality of types of UE capability identifier and/or indication separated from each other to be used with the network 20. The processor 11 is configured to use the PLMN UE capability identifier and/or indication.

In some implementations, when the processor 11 intends to switch to the manufacturer UE capability identifier and/or indication, the processor 11 initiates a registration request procedure and the memory 12 includes the manufacturer UE capability identifier and/or indication and a previously assigned PLMN UE capability identifier and/or indication from the network 20. Whenever the processor 13 performs the registration request procedure, the memory includes the manufacturer UE capability identifier and/or indication and the previously assigned PLMN UE capability identifier and/or indication. Whenever the UE 10 moves to a different PLMN, the memory 12 includes the manufacturer UE capability identifier and/or indication and does not include the previously assigned PLMN UE capability identifier and/or indication.

In some implementations, the processor 21 is configured to control the transceiver 23 to transmit, to the UE 10, an indication that one of a plurality of types of UE capability identifier and/or indication separated from each other is to be used and the processor 21 is configured to manage UE capability information using the one of the plurality of types of UE capability identifier and/or indication separated from each other.

In some implementations, the plurality of types of UE capability identifier and/or indication include a manufacturer UE capability identifier and/or indication and a public land network based on public land mobile network (PLMN) UE capability identifier and/or indication. The manufacturer UE capability identifier and/or indication and the PLMN UE capability identifier and/or indication are separately maintained in separate identifier and/or indication pools.

In some implementations, the transceiver 23 is configured to receive the manufacturer UE capability identifier and/or indication from the UE 10. The transceiver 23 transmits, to the UE 10, a determination that the network 20 does not support the manufacturer UE capability identifier and/or indication or the network 20 rejects to use the manufacturer UE capability identifier and/or indication when the transceiver 23 receives the manufacturer UE capability identifier and/or indication from the UE 10. The transceiver 23 transmits, to the UE 10, a request of providing the UE capability information when the transceiver 23 transmits, to the UE 10, the determination that the network 20 does not support the manufacturer UE capability identifier and/or indication or the network 20 rejects to use the manufacturer UE capability identifier and/or indication.

In some implementations, the transceiver 23 receives the UE capability information from the UE 10 when the transceiver 23 transmits, to the UE 10, the request of providing the UE capability information. The transceiver 23 transmits, to the UE 10, an allocation of the PLMN UE capability identifier and/or indication when the transceiver 23 receives the UE capability information from the UE 10. The processor 21 is configured to negotiate another of the plurality of types of UE capability identifier and/or indication separated from each other to be used with the UE 10. The processor 21 is configured to use the PLMN UE capability identifier and/or indication.

FIG. 2 illustrates a method 200 for managing user equipment (UE) capability information of a user equipment according to an implementation of the present disclosure. The method 200 includes: at block 202, receiving an indication that one of a plurality of types of UE capability identifier and/or indication separated from each other is to be used from a network, and at block 204, managing UE capability information using the one of the plurality of types of UE capability identifier and/or indication separated from each other.

In some implementations, the plurality of types of UE capability identifier and/or indication include a manufacturer UE capability identifier and/or indication and a public land network based on public land mobile network (PLMN) UE capability identifier and/or indication.

In some implementations, the method further includes optionally configuring the manufacturer UE capability identifier and/or indication. The manufacturer UE capability identifier and/or indication and the PLMN UE capability identifier and/or indication are separately maintained in separate identifier and/or indication pools. In some implementations, the method further includes reporting, to the network, the manufacturer UE capability identifier and/or indication.

In some implementations, the method further includes receiving a determination that the network does not support the manufacturer UE capability identifier and/or indication or the network rejects to use the manufacturer UE capability identifier and/or indication when the method includes reporting, to the network, the manufacturer UE capability identifier and/or indication. In some implementations, the method further includes receiving a request of providing the UE capability information from the network when the method includes receiving the determination that the network does not support the manufacturer UE capability identifier and/or indication or the network rejects to use the manufacturer UE capability identifier and/or indication.

In some implementations, the method further includes reporting, to the network, the UE capability information when the method includes receiving the request of providing the UE capability information from the network. In some implementations, the method further includes receiving an allocation of the PLMN UE capability identifier and/or indication when the method includes reporting, to the network, the UE capability information. In some implementations, the method further includes negotiating another of the plurality of types of UE capability identifier and/or indication separated from each other to be used with the network.

In some implementations, the method further includes using the PLMN UE capability identifier and/or indication. In some implementations, the method further includes intending to switch to the manufacturer UE capability identifier and/or indication and initiating a registration request procedure, the UE includes the manufacturer UE capability identifier and/or indication and a previously assigned PLMN UE capability identifier and/or indication from the network. In some implementations, the method further includes whenever performing the registration request procedure, the UE includes the manufacturer UE capability identifier and/or indication and the previously assigned PLMN UE capability identifier and/or indication. In some implementations, the method further includes whenever the UE moves to a different PLMN, the UE includes the manufacturer UE capability identifier and/or indication and does not include the previously assigned PLMN UE capability identifier and/or indication.

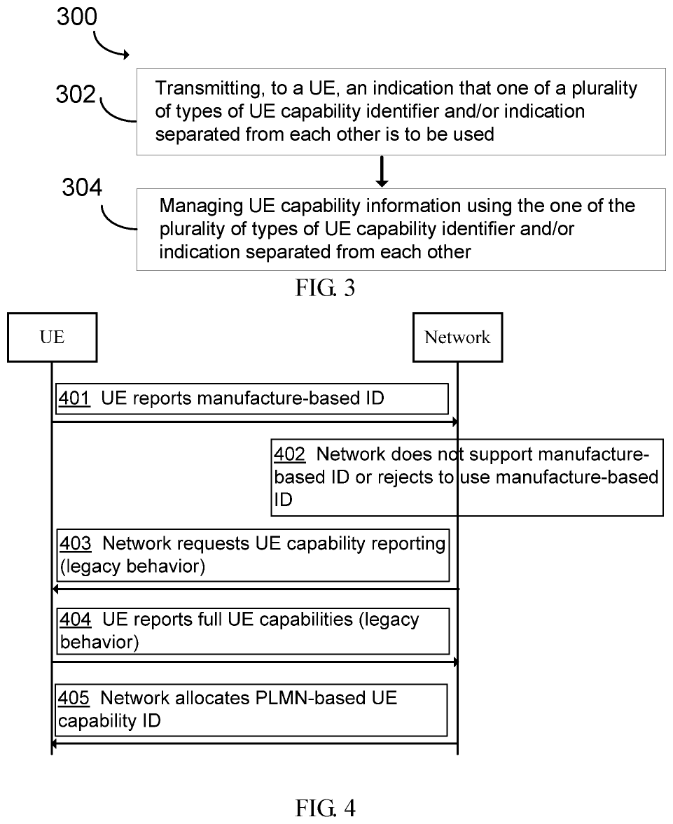

FIG. 3 illustrates a method 300 for managing user equipment (UE) capability information of a network according to an implementation of the present disclosure. The method 300 includes: at block 302, transmitting, to a UE, an indication that one of a plurality of types of UE capability identifier and/or indication separated from each other is to be used, and at block 304, managing UE capability information using the one of the plurality of types of UE capability identifier and/or indication separated from each other.

In some implementations, the plurality of types of UE capability identifier and/or indication include a manufacturer UE capability identifier and/or indication and a public land network based on public land mobile network (PLMN) UE capability identifier and/or indication. The manufacturer UE capability identifier and/or indication and the PLMN UE capability identifier and/or indication are separately maintained in separate identifier and/or indication pools.

In some implementations, the method further includes receiving the manufacturer UE capability identifier and/or indication from the UE. In some implementations, the method further includes transmitting, to the UE, a determination that the network does not support the manufacturer UE capability identifier and/or indication or the network rejects to use the manufacturer UE capability identifier and/or indication when the method includes receiving the manufacturer UE capability identifier and/or indication from the UE. In some implementations, the method further includes transmitting, to the UE, a request of providing the UE capability information when the method includes transmitting, to the UE, the determination that the network does not support the manufacturer UE capability identifier and/or indication or the network rejects to use the manufacturer UE capability identifier and/or indication.

In some implementations, the method further includes receiving the UE capability information from the UE when the method includes transmitting, to the UE, the request of providing the UE capability information. In some implementations, the method further includes transmitting, to the UE, an allocation of the PLMN UE capability identifier and/or indication when the method includes receiving the UE capability information from the UE.

In some implementations, the method further includes negotiating another of the plurality of types of UE capability identifier and/or indication separated from each other to be used with the UE. In some implementations, the method further includes using the PLMN UE capability identifier and/or indication.

An example as below is to explain a user equipment and a network for managing user equipment (UE) capability information according to an implementation of the present disclosure.

It is assumed that one UE supports 15 bands and the UE supports 2 downlink (DL) CA, 3 DL CA, 5 DL CA, and 2 UL CA. It is further assumed all those 15 bands belong to valid CA combinations. It's easy to tell total # of CA combinations is: (15 choose 2)+(15 choose 3)+(15 choose 5). Only (15 choose 5) already gives 3003 different band combinations. Recall that it also has 2 UL CA, meaning each combination needs to report which UL is the primary UL. This will again double the number of combinations to report. Each band combination needs about 32 bytes. Clearly, when the # of supported bands increase, the UE capability size can become very large. With the introduction of 5G, it's safe to provide the UE will support much more bands than in 4G. Therefore, 3GPP may initiate a discussion on how to optimize UE capability reporting.

One method is to use UE capability ID. The idea is both UE and network use ID to identify a set of UE capability. The network can be provisioned by UE manufactures of UE capability sets and the corresponding IDs. Therefore, during capability reporting, the UE only needs to send an ID, instead of whole capability. As for now, there are two types of UE IDs in discussion: manufacture-based ID and PLMN-based ID. It remains open that how those two types of IDs are handled by the UE and network.

Relevant discussions in tables 1 and 2 have been captured in 3GPP TR 23.743 as follows.

TABLE 1
Solution #1: UE manufacturer-specific UE capability ID
Introduction
This solution addresses Key Issue #1 (How are the UE capabilities identified?).
Functional Description
In this solution the UE Radio Capabilities are identified with a UE capability ID that has the following salient
characteristics:
The UE capability ID is a short pointer (e.g. 2-3 octets; the exact size is to be determined by RAN)
that together with the UE manufacturer information (e.g. TAC field in the PEI) uniquely identifies a set
of UE Radio Capabilities.
Editor's note: The detailed manufacturer information will be discussed in normative work.
The UE manufacturer information uniquely identifies the UE manufacturer.
The UE capability ID is assigned by the UE manufacturer.
The UE is configured with one or more UE capability IDs that map into distinct set of UE Radio
Capabilities.
At any given instant the UE has only one UE capability ID that is indicated to the network.
The UE capability ID identifies the UE radio capabilities set that can be specific to one or multiple
RAT types.
Procedures
Solutions to other key issues will explain how the UE capability ID is used in relevant procedures.
Impacts on existing entities and interfaces
Solutions to other key issues will explain how the UE capability ID impacts existing entities and interfaces.

TABLE 2
Solution #8: Solution for identifying UE radio capabilities using PLMN-specific UE Capability ID
Introduction
Editor's note: This clause lists the key issue(s) addressed by this solution.
The following requirements apply to this solution:
1. It shall be possible to optionally identify the UE capabilities with a manufacturer assigned identifier
(as in solution #1 of the present document)
2. If manufacturer assigned identifier is not used, a PLMN specific one can be used by serving AMF
3. It shall be possible for the network or the device to change the UE Capability ID associated with a
device, e.g., due to a SW upgrade enabling new capabilities on the device side or for rennapping or
OAM procedures in the network side.
UE Capability ID format is split in two name/number-spaces:
Globally assigned by UE manufacturer as in solution #1 - Operator specific - this could be
preconfigured by operators as part of device certification, or assigned by the operator the first time
any UE reports these capabilities on the network
Additionally, the UE Capability ID may be permanent or semi-statically associated with a device. Since a
device may have certain features upgraded, e.g., due to a new SW release, a more flexible approach
would be to allow the capability-profile-ID to be semi-statically defined and not associated with a
permanent device ID such as IMEI.
Functional Description
Editor's note: This clause outlines solution principles and documents any assumptions
made.
UE radio capabilities are identified by a newly defined UE Capability ID. The format of UE Capability ID is
split in
1. A manufacturer specific (as in sol.1 of TR 23.743) UE Capability ID(s) can be optionally configured in
the UE e,g. upon manufacturing.
2. If UE is configured with Manufacturer specific UE Capability ID, UE reports that at initial Registration
in a PLMN based on capabilities it wants to use.
3. Serving PLMN AMF:
i. if it has access to mapping of Manufacturer specific UE Capability ID to radio capabilities can
provide stored radio capabilities to RAN.
ii. if it does NOT have access to mapping of Manufacturer specific UE Capability ID or does not
want to use it can query the UEs radio capabilities and then provide an PLMN specific UE
Capability ID for future indications e.g. using UE Configuration Update as defined.
4. If UE is configured with PLMN-specific UE Capability ID it provides the PLMN specific one on this
PLMN only.
5. Else if UE is not configured with any UE Capability ID, query capabilities and then provide a PLMN
specific UE Capability ID for future indications.
If memory for storing UE radio capabilities is a concern, it is up to AMF implementation to provide the same
PLMN specific UE Capability ID to multiple different UEs with the same radio capabilities e.g. same
model/manufacturer.
NOTE: How long the same PLMN-specific UE Capability ID can be kept in the UE and AMF depends
on local operator policy.
Procedures
Editor's note: This clause describes high-level procedures and information flows for the
solution.
None.
NOTE: How to handle PLMN specific UE Capability ID in case there is no PLMN-wide support of
certain UE radio capabilities and RAN filtering is applied will be resolved in key issues 2 and
3.
Impacts on existing entities and interfaces
Editor's note: This clause describes impacts to existing entities and interfaces.
UE, NG-RAN, and CN (if radio capabilities are stored there) will have to manage UE radio capabilities
using UE Capability ID.
Evaluation
Editor's note: This clause provides an evaluation of the solution.
This solution builds on top of solution 1 and allows UE Capability ID to be assigned by (serving) PLMN if
Manufacturer UE Capability ID is not used.

The implementation describes how to handle two types of UE capability ID. In some implementations, with two types of UE capability IDs (such as manufacture-based capability ID and PLMN-based capability ID), the UE and the network fully in sync on which type of ID is currently in use. Otherwise, the network may map the capability ID to a wrong capability set. This may cause UE out of service.

In some implementations, two types of UE capability ID are separately maintained at the UE and the network. The UE is further implicitly or explicitly notified by the network which type of UE ID is to be used.

In some implementations, one method is to have separate ID pools to allow both end (such as the UE and Network) understand which type ID it is. E.g. IDs starting with or containing a specific number or symbol represent manufacture-based; and IDs starting with or containing another specific number or symbol represent PLMN-based.

In some implementations, another method is the network use a flag in RRC/NAS message to indicate which type of ID is in use.

Examples of manufacture-based ID and PLMN-based ID are illustrated in following tables 3 and 4. In the example, ID range from 100 is reserved for manufacture-based ID and ID range from 200 is reserved for PLMN-based ID. Another method is to use a different letter to indicate two types of ID, e.g. using M100 for manufactured ID and using P100 for PLMN-based ID.

TABLE 3
manufacture-based ID database

| UE manufacture | ID | UE capability description (example) |
|---|---|---|
| xxx | 100 | 5DL CA band combos and 3DL CA band combos |
| xxx | 101 | only 3DL CA band combos |
| xxx | 102 | not support CA |
| xxx | 103 | an MTC UE |

TABLE 4
PLMN-based ID database

| ID | UE capability description (example) |
|---|---|
| 200 | an MTC UE |
| 201 | not support CA |
| 202 | only 3DL CA band combos |
| 203 | 5DL CA band combos and 3DL CA band combos |

In some implementations, another issue to address is how the UE and network switch between two types of UE capability IDs. When the UE does not have PLMN-based ID, it will report manufacture-based ID to the network. However, it's possible manufacture-based ID is not available, due to:

The network does not support manufacture-based ID; or

The network does not want to use manufacture-based ID.

In some implementations, in the above two cases, the network will reply to the UE with PLMN-based ID. According to the above example, the UE understands the ID type. The procedure is illustrated in FIG. 4. The method includes: at block 401, the UE reports manufacture-based ID, at block 402, the network does not support manufacture-based ID or rejects to use manufacture-based ID, at block 403, the network requests UE capability reporting (legacy behavior), at block 404, the UE reports full UE capabilities (legacy behavior), and at block 405, the network allocates PLMN-based UE capability ID.

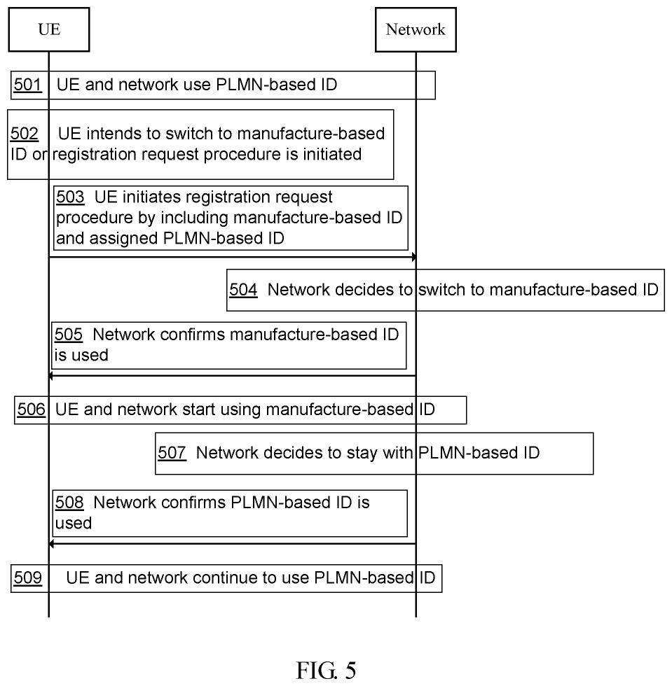

In some implementations, it is provided that the UE intends to switch to manufacture-based ID whenever it become applicable since manufacture-based ID. Therefore, the implementation defines when and how the UE re-negotiate with the network about ID type. In some implementations, the UE and the network are able to re-negotiate which type of ID is to be used. In some implementations, whenever the UE intends to switch to manufacture-based ID, the UE initiates registration request procedure and includes manufacture-based ID as well as the previously assigned PLMN-based ID. In some implementations, whenever the UE performs registration request procedure (due to any reason), the UE always includes manufacture-based ID as well as the previously assigned PLMN-based ID. FIG. 5 illustrates the above example. The method includes: at block 501, the UE and the network use PLMN-based ID, at block 502, the UE intends to switch to manufacture-based ID or registration request procedure is initiated, at block 503, the UE initiates registration request procedure by including manufacture-based ID and assigned PLMN-based ID, at block 504, the network decides to switch to manufacture-based ID, at block 505, the network confirms manufacture-based ID is used, at block 506, the UE and the network start using manufacture-based ID, at block 507, the network decides to stay with PLMN-based ID, at block 508, the network confirms PLMN-based ID is used, and at block 509, the UE and the network continue to use PLMN-based ID.

In some implementations, whenever the UE moves to a different PLMN, the UE always includes manufacture-based ID. The UE does not include the previously assigned PLMN-based ID (as it is invalid in new PLMN).

In some implementations, using UE capability ID to optimize UE capability reporting is an ongoing work item in 3GPP and likely to be adopted in 3GPP Rel-16. This implementation addresses a few open issues of handling UE capability IDs.

In some implementations, with the support of two types UE capability IDs, the implementation describes how to allow the UE and the network to be in sync on which type of ID to use. The implementation further describes several methods to allow the UE and the network switch between two types of UE ID.

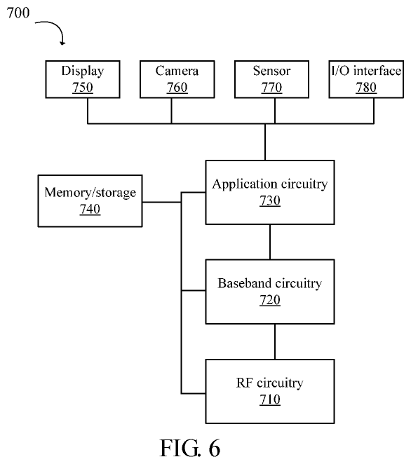

FIG. 6 is a block diagram of an example system 700 for wireless communication according to an implementation of the present disclosure. Implementations described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some implementations, the baseband circuitry may provide for communication compatible with one or more radio technologies. For example, in some implementations, the baseband circuitry may support communication with an evolved universal terrestrial radio access network (EUTRAN) and/or other wireless metropolitan area networks (WMAN), a wireless local area network (WLAN), a wireless personal area network (WPAN). Implementations in which the baseband circuitry is configured to support radio communications of more than one wireless protocol may be referred to as multi-mode baseband circuitry.

In various implementations, the baseband circuitry 720 may include circuitry to operate with signals that are not strictly considered as being in a baseband frequency. For example, in some implementations, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various implementations, the RF circuitry may include switches, filters, amplifiers, etc. to facilitate the communication with the wireless network.

In various implementations, the RF circuitry 710 may include circuitry to operate with signals that are not strictly considered as being in a radio frequency. For example, in some implementations, RF circuitry may include circuitry to operate with signals having an intermediate frequency, which is between a baseband frequency and a radio frequency.

In various implementations, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some implementations, the electronic device circuitry may be implemented in, or functions associated with the circuitry may be implemented by, one or more software or firmware modules.

In some implementations, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one implementation may include any combination of suitable volatile memory, such as dynamic random access memory (DRAM)), and/or non-volatile memory, such as flash memory.

In various implementations, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various implementations, the sensor 770 may include one or more sensing devices to determine environmental conditions and/or location information related to the system. In some implementations, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various implementations, the display 750 may include a display, such as a liquid crystal display and a touch screen display. In various implementations, the system 700 may be a mobile computing device such as, but not limited to, a laptop computing device, a tablet computing device, a netbook, an ultrabook, a smartphone, etc. In various implementations, system may have more or less components, and/or different architectures. Where appropriate, methods described herein may be implemented as a computer program. The computer program may be stored on a storage medium, such as a non-transitory storage medium.

In the implementation of the present disclosure, an apparatus and a method of for managing user equipment (UE) capability information capable of providing high reliability are provided. The implementation of the present disclosure is a combination of techniques/processes that can be adopted in 3GPP specification to create an end product.

A person having ordinary skill in the art understands that each of the units, algorithm, and steps described and disclosed in the implementations of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned implementation since the working processes of the above-mentioned system, device, and unit are basically the same. For easy description and simplicity, these working processes will not be detailed.

It is understood that the disclosed system, device, and method in the implementations of the present disclosure can be realized with other ways. The above-mentioned implementations are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the implementations. Moreover, each of the functional units in each of the implementations can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the implementations of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred implementations, it is understood that the present disclosure is not limited to the disclosed implementations but is intended to cover various arrangements made without departing from the scope of the broadest interpretation of the appended claims.

What is claimed is:

1. A user equipment (UE) for managing UE capability information, comprising:
a memory;
a transceiver; and
a processor coupled to the memory and the transceiver,
wherein the processor is configured to:
control the transceiver to receive an indication that one of a plurality of types of UE capability identifier is to be used from a network; and
manage UE capability information using the one of the plurality of types of UE capability identifier.

2. The UE of claim 1, wherein the plurality of types of UE capability identifier comprise a manufacturer UE capability identifier and a public land network based on public land mobile network (PLMN) UE capability identifier.

3. The UE of claim 2, wherein the manufacturer UE capability identifier is optionally configured in the UE.

4. The UE of claim 2, wherein the manufacturer UE capability identifier and/or indication and the PLMN UE capability identifier and/or indication are separately maintained in separate identifier pools.

5. The UE of claim 2, wherein the transceiver is configured to report, to the network, the manufacturer UE capability identifier.

6. The UE of claim 5, wherein the transceiver receives a determination that the network does not support the manufacturer UE capability identifier and/or indication or the network rejects to use the manufacturer UE capability identifier and/or indication when the transceiver reports, to the network, the manufacturer UE capability identifier and/or indication.

7. The UE of claim 6, wherein the transceiver receives a request of providing the UE capability information from the network when the transceiver receives the determination that the network does not support the manufacturer UE capability identifier and/or indication or the network rejects to use the manufacturer UE capability identifier and/or indication.

8. A method for managing user equipment (UE) capability information of a UE, comprising:
receiving an indication that one of a plurality of types of UE capability identifier is to be used from a network; and
managing UE capability information using the one of the plurality of types of UE capability identifier.

9. The method of claim 8, wherein the plurality of types of UE capability identifier comprise a manufacturer UE capability identifier and a public land network based on public land mobile network (PLMN) UE capability identifier.

10. The method of claim 9, further comprising optionally configuring the manufacturer UE capability identifier.

11. The method of claim 9, wherein the manufacturer UE capability identifier and/or indication and the PLMN UE capability identifier and/or indication are separately maintained in separate identifier pools.

12. The method of claim 9, further comprising reporting, to the network, the manufacturer UE capability identifier.

13. The method of claim 12, further comprising receiving a determination that the network does not support the manufacturer UE capability identifier and/or indication or the network rejects to use the manufacturer UE capability identifier and/or indication when the method comprises reporting, to the network, the manufacturer UE capability identifier and/or indication.

14. The method of claim 13, further comprising receiving a request of providing the UE capability information from the network when the method comprises receiving the determination that the network does not support the manufacturer UE capability identifier and/or indication or the network rejects to use the manufacturer UE capability identifier and/or indication.

15. A network for managing user equipment (UE) capability information, comprising:
a memory;
a transceiver; and
a processor coupled to the memory and the transceiver,
wherein the processor is configured to:
control the transceiver to transmit, to a UE, an indication that one of a plurality of types of UE capability identifier is to be used; and
manage UE capability information using the one of the plurality of types of UE capability identifier.

16. The network of claim 15, wherein the plurality of types of UE capability identifier comprise a manufacturer UE capability identifier and a public land network based on public land mobile network (PLMN) UE capability identifier.

17. The network of claim 16, wherein the manufacturer UE capability identifier and/or indication and the PLMN UE capability identifier and/or indication are separately maintained in separate identifier pools.

18. The network of claim 16, wherein the transceiver is configured to receive the manufacturer UE capability identifier from the UE.

19. The network of claim 18, wherein the transceiver transmits, to the UE, a determination that the network does not support the manufacturer UE capability identifier and/or indication or the network rejects to use the manufacturer UE capability identifier and/or indication when the transceiver receives the manufacturer UE capability identifier and/or indication from the UE.

20. The network of claim 19, wherein the transceiver transmits, to the UE, a request of providing the UE capability information when the transceiver transmits, to the UE, the determination that the network does not support the manufacturer UE capability identifier and/or indication or the network rejects to use the manufacturer UE capability identifier and/or indication.
